(19) United States
(12) Patent Application Publication
(10) Pub. No.: US 2024/0226985 A1
(43) Pub. Date: Jul. 11, 2024

(54) ORIENTATION ELEMENT FOR PUNCH RETAINER AND PUNCH FOR USE THEREWITH

(71) Applicant: MOELLER PRECISION TOOL, LLC, Wixom, MI (US)

(72) Inventors: David J. Moellering, Orchard Lake, MI (US); Aziz Sönmez, Wipperfürth (DE)

(21) Appl. No.: 18/563,239

(22) PCT Filed: May 25, 2022
(86) PCT No.: PCT/US2022/030798

§ 371 Date: Nov. 21, 2023

(51) Int. Cl. B21D 28/34

(52) U.S. Cl. CPC B21D 28/34

(57) ABSTRACT

A punch system includes a punch with a ball lock recess and an arcuate slot each defined in the side surface of the base. A punch retainer has a retainer body with a generally circular punch hole extending from an outer face towards a mounting surface. A spring loaded ball is biased into a locking position extending into the punch hole. A dowel hole is defined in the outer face adjacent to the punch hole and partially overlapping therewith. A cylindrical dowel is received in the dowel hole with a portion extending into the punch hole to define an arcuate protrusion, thus defining an orientation element with a shape complementary to the arcuate slot and positioned such that the base of the punch is only insertable in an orientation in which the ball lock recess in the base of the punch is rotationally aligned with the spring loaded ball.

### CROSS-REFERENCE TO RELATED APPLICATIONS

This application is the U.S. National Stage of PCT/US2022/030798 filed on May 25, 2022, which claims priority to U.S. Provisional Patent Application Ser. No. 63/193,630, filed May 27, 2021, all of which is hereby incorporated by reference in its entirety.

### FIELD OF THE INVENTION

The present invention relates to punches and punch retainers for use with punch presses.

### BACKGROUND OF THE INVENTION

Punches are widely used in punch presses in the stamping industry to pierce materials, such as sheet metal. There are a number of approaches to retaining a punch on a punch press, with one common approach being to use a ball lock punch retainer as disclosed in U.S. Pat. No. 5,357,835, to Moellering (the “'835 patent”), the entire contents of which is incorporated herein by reference.

FIGS. 1 and 2 are drawings of a design originally presented in the '835 patent and show a retainer having a body 10 with various holes therein. FIG. 1 is a top view of the retainer and FIG. 2 is a cross-sectional view of the retainer of FIG. 1 taken along lines 2-2. Some of the holes in the retainer are used for fasteners or locating dowels. Of primary relevance is the punch hole 22 which is designed to receive and retain a punch. When the body 10 is mounted to a punch press, and a punch is retained in the punch hole, the punch will be operable to pierce materials when moved by the punch press.

Typically, the punch hole 22 is designed for use with a punch having a base with a circular cross section, and therefore the punch hole is circular. In the example of FIGS. 1 and 2, the punch hole 22 terminates in a flat bottom 24, with the flat bottom taking the punching load when the punch pierces material. Alternatively, a retainer may have punch hole that extends to the bottom surface of the retainer with the punch bottoming on the punch press or an additional backing plate.

FIG. 3 shows a typical punch for use with a punch retainer of the type shown in FIGS. 1 and 2. The punch has a generally cylindrical base (at the top in this FIG.) and has a recess 52 in the side of the base, spaced from the bottom of the punch. As shown in FIG. 2, the punch hole 22 has a ball 34 that is biased by a spring 36 into a position partially extending into the punch hole 22. When the base of the punch is inserted into the punch hole 22, the ball is pushed back against the spring to allow the base to extend into the hole. The recess 52 is positioned to receive the ball. However, the recess 52 is located at only one circumferential position on the base and, because the punch base is circular in cross section, the punch must be rotationally positioned such that the ball is received into the recess. Typically, the punch is inserted and then rotated until the ball drops into recess. An audible click is heard. However, in a noisy environment, an operator may not hear the click and may be unsure if the ball is properly seated. If the punch is not properly retained, serious complications may occur. As such, there is a need for methods and structures to rotationally orient a punch in a punch retainer

### SUMMARY OF THE INVENTION

The present invention provides a punch retainer with an orientation element extending into the punch hole for rotationally orienting the base of the punch such that the ball is rotationally aligned with the recess in the base of the punch. The present invention also provides a punch for use with such a retainer, and a system including both the punch and retainer. A method is also provided. Various approaches may be used.

In one embodiment, a punch system is provided for use with a punch press. The punch system includes a punch and a punch retainer configured to receive and retain the punch. The punch has a punch body with a tip for piercing material and a base to be received in the punch retainer. A ball lock recess is defined in a side surface of the base. An alignment feature is defined in the side surface of the base, extending from an end surface of the base towards the tip. Another suitable term for alignment feature is alignment element. The punch retainer has a retainer body with a mounting surface for attachment to a punch press and an opposite outer face. A punch hole extends from the outer face at least part way to the mounting surface for receiving the base of the punch, the punch hole having a generally circular cross section. A spring loaded ball is biased into a locking position wherein the ball partially extends into the punch hole. An orientation element extending partially into the punch hole is provided, the orientation element having a shape complementary to the alignment element in the base of the punch such that the base of the punch is only insertable into the punch hole in an orientation in which the ball lock recess in the base of the punch is rotationally aligned with the spring loaded ball. The alignment feature and the orientation element thus are complementary to each other and work functionally together.

In certain examples, the alignment feature comprises a slot, said slot being defined in the side surface of the base, extending from an end surface of the base towards the tip, the slot having an arcuate cross section.

In certain examples, the punch retainer comprises a dowel hole, said dowel hole being defined in the outer face adjacent to the punch hole and partially overlapping therewith. A cylindrical dowel is received in the dowel hole such that a portion of a side of the cylindrical dowel extends partially into the punch hole so as to define an arcuate protrusion, the arcuate protrusion defining the orientation element, wherein preferably the arcuate protrusion having a shape complementary to the arcuate slot in the side surface of the punch.

In certain examples, the dowel hole has a depth less than a depth of the punch hole. In further examples, the slot in the side surface of the punch has a length greater than the depth of the punch hole and less than a sum of the depth of the punch hole and the depth of the dowel hole, such that the dowel cannot exit the dowel hole when the punch is retained in the punch retainer. Less than 50% of the dowel may define the arcuate protrusion and more than 50% of the dowel may be embedded in the retainer body.

In certain examples, the punch hole has a depth and the slot in the side surface of the punch has a length greater than the depth of the punch hole and less than a length of the punch. The length of the slot may be in the range of 100% to 120% of the depth of the punch hole.

In certain examples, the alignment feature of the punch is disposed 180 degrees from the ball lock recess.

In a second embodiment, a punch is provided for use with a ball lock punch retainer having an orientation element extending partially into a punch hole in the retainer. The punch has a punch body with a tip for piercing material and a base to be received in the punch retainer. A ball lock recess is defined in a side surface of the base. An alignment feature is defined in the side surface of the base, extending from an end surface of the base towards the tip, the alignment feature being configured to be complementary to the orientation element. The alignment feature is preferably positioned such that when the punch is inserted into a punch retainer, the punch is receivable in the punch retainer only with the ball lock recess rotationally positioned in line with the ball lock of the punch retainer.

In certain examples, the alignment feature of the punch is a slot in the side surface of the base. In some versions, the slot has an arcuate cross section and the orientation element is an arcuate protrusion complementary to the arcuate slot.

In certain examples, the punch hole in the retainer has a depth and the slot in the side surface of the punch has a length greater than the depth of the punch hole and less than a length of the punch. The length of the slot may be in the range of 100% to 120% of the depth of the punch hole.

In certain examples, the alignment feature of the punch is disposed 180 degrees from the ball lock recess.

In a third embodiment, a punch retainer is provided for use with a punch of the type having a base with a generally circular cross section and a recess for receiving a ball. The punch retainer has a retainer body with a mounting surface for attachment to a punch press and an opposite outer face. A punch hole extends from the outer face at least part way to the mounting surface for receiving the base of the punch, the punch hole having a generally circular cross section. A spring loaded ball is biased into a locking position wherein the ball partially extends into the punch hole. An orientation element extends partially into the punch hole, the orientation element being configured to having a shape complementary to an alignment feature in the base of a punch such that when a punch is inserted into the punch retainer the base of the punch is only insertable into the punch hole in an orientation in which the recess in the base of the punch is rotationally aligned with the spring loaded ball.

In certain examples, the punch retainer also includes a cylindrical dowel and a dowel hole defined in the outer face adjacent to the punch hole and partially overlapping therewith. The cylindrical dowel is received in the dowel hole such that a portion of a side of the cylindrical dowel extends partially into the punch hole so as to define an arcuate protrusion, the arcuate protrusion defining the orientation element.

In certain examples, the dowel hole has a depth less than a depth of the punch hole. In some versions, the slot in the side surface of the punch has a length greater than the depth of the punch hole and less than a sum of the depth of the punch hole and the depth of the dowel hole, such that the dowel cannot exit the dowel hole when the punch is retained in the punch retainer.

In some versions, less than 50% of the dowel defines the arcuate protrusion and more than 50% of the dowel is embedded in the retainer body.

In certain examples, the orientation element is disposed 180 degrees from the spring-loaded ball.

A fourth embodiment is a method of providing a punch system for use with a punch press. The method includes providing a punch body with a tip for piercing material and a base to be received in a punch retainer. A ball lock recess is defined in a side surface of the base. An alignment feature is defined in the side surface of the base, extending from an end surface of the base towards the tip. A punch retainer body is provided, having a mounting surface for attachment to a punch press and an opposite outer face. A punch hole is defined extending from the outer face at least part way to the mounting surface for receiving the base of the punch, the punch hole having a generally circular cross section. A spring loaded ball is provided, which is biased into a locking position wherein the ball partially extends into the punch hole. An orientation element is provided, extending partially into the punch hole, the orientation element having a shape complementary to an alignment feature in the base of the punch such that the base of the punch is only insertable into the punch hole in an orientation in which the recess in the base of the punch is rotationally aligned with the spring loaded ball.

In certain examples, the step of providing the orientation element in the punch retainer body includes: defining a dowel hole in the outer face adjacent to the punch hole and partially overlapping therewith; providing a cylindrical dowel; and receiving the cylindrical dowel in the dowel hole such that a portion of a side of the cylindrical dowel extends partially into the punch hole so as to define an arcuate protrusion, the arcuate protrusion defining the orientation element.

In some versions, the step of defining the dowel hole includes defining a dowel hole with a depth less than a depth of the punch hole. In further versions, the step of defining the alignment feature in the side surface of the punch includes defining a slot having an arcuate cross section, the slot having a length greater than the depth of the punch hole and less than a sum of the depth of the punch hole and the depth of the dowel hole, such that the dowel cannot exit the dowel hole when the punch is retained in the punch retainer. In yet further versions, the step of defining the dowel hole includes positioning the dowel hole such that less than 50% of the dowel defines the arcuate protrusion and more than 50% of the dowel is embedded in the retainer body.

In certain examples, the orientation element is disposed 180 degrees from the spring-loaded ball.

### BRIEF DESCRIPTION OF THE DRAWINGS

FIG. 1 is a top view of a prior art ball lock punch retainer;

FIG. 2 is a cross sectional view of the ball lock punch retainer of FIG. 1, taken along lines 2-2;

FIG. 3 is a side view of a prior art punch for use with the ball lock punch retainer of FIGS. 1 and 2;

FIG. 4 is a perspective view of a punch system in accordance with an embodiment of the present invention;

FIG. 5 is another perspective view of the punch system of FIG. 4;

FIG. 6 is a perspective view of a punch that forms part of the punch system of FIGS. 4 and 5 and that also forms an embodiment of the present invention;

FIG. 7 is another perspective view of the punch of FIG. 6;

FIG. 8 is a side view of the punch of FIGS. 6 and 7;

FIG. 9 is an end view of the punch of FIGS. 6-8;

FIG. 10 is a top view of a punch retainer that forms part of the punch system of FIGS. 4 and 5 and that also forms an embodiment of the present invention;

FIG. 11 is a cross sectional side view of the punch retainer of FIG. 10; and

FIG. 12 is an exploded view of the punch system of FIGS. 4 and 5.

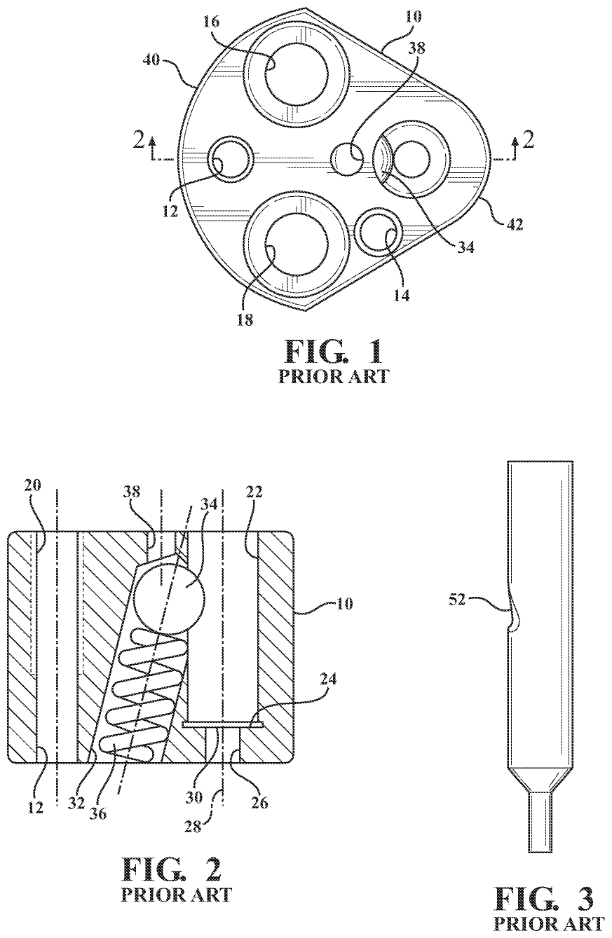

### DETAILED DESCRIPTION OF THE INVENTION

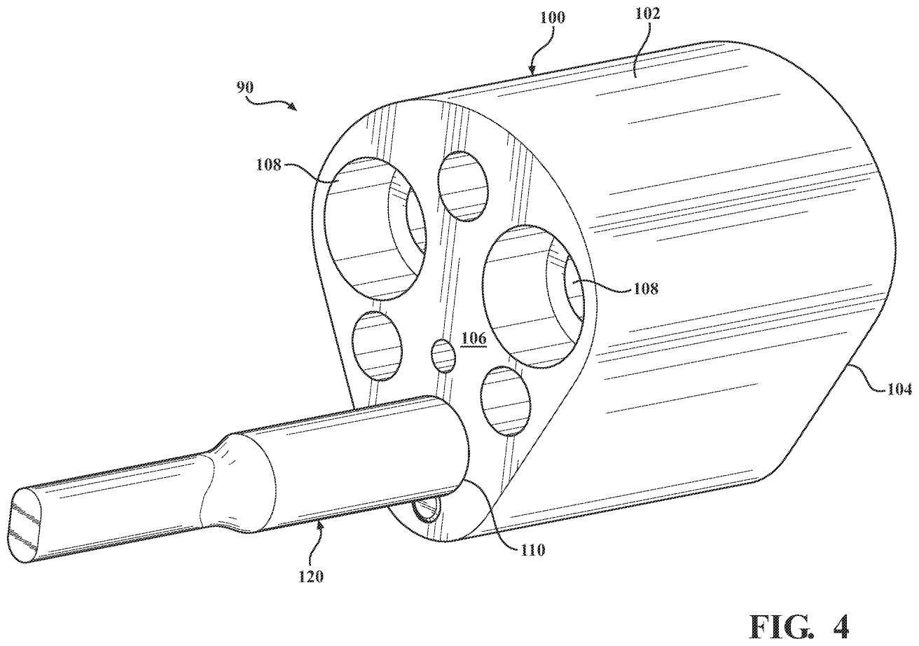

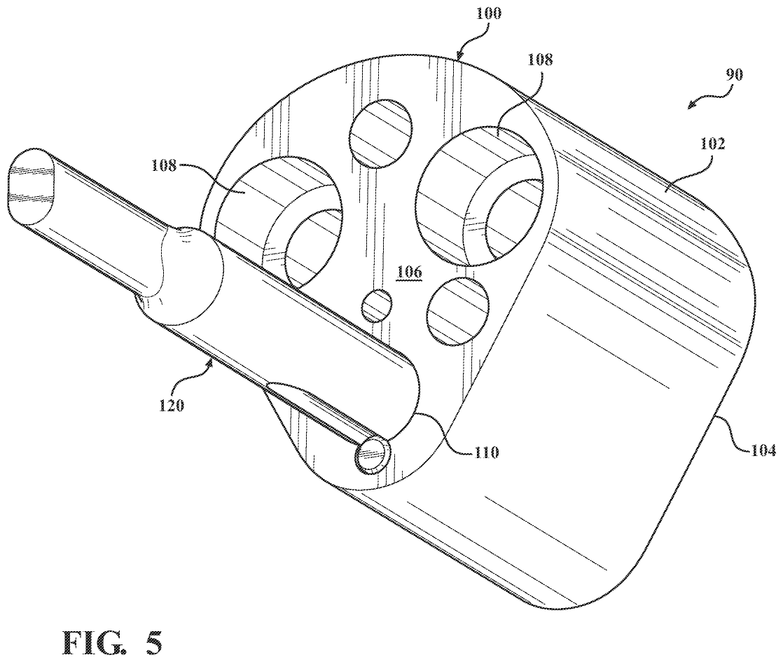

Referring to FIGS. 4 and 5, a punch system 90 in accordance with an aspect of the present invention is shown. The punch system 90 includes a punch retainer 100 and a punch 120, each of which also separately form aspects of the present invention. The punch retainer 100 has a retainer body 102 with a mounting surface 104 to be attached to a punch press. An outer face 106 is opposite the mounting surface 104 and has a plurality of holes provided therein. These holes include fastener holes 108 which may receive fasteners for mounting the retainer to the punch press. These holes may be arranged differently than shown. Additional holes may be for positioning dowels for locating the retainer on the punch press. These additional holes may be arranged as necessary for proper positioning. The retainer body may have a different overall shape than shown, and the sizes of the punch retainer and the punch may vary depending on the application.

The punch retainer body 102 further has a punch hole 110 for receiving the base of the punch 120.

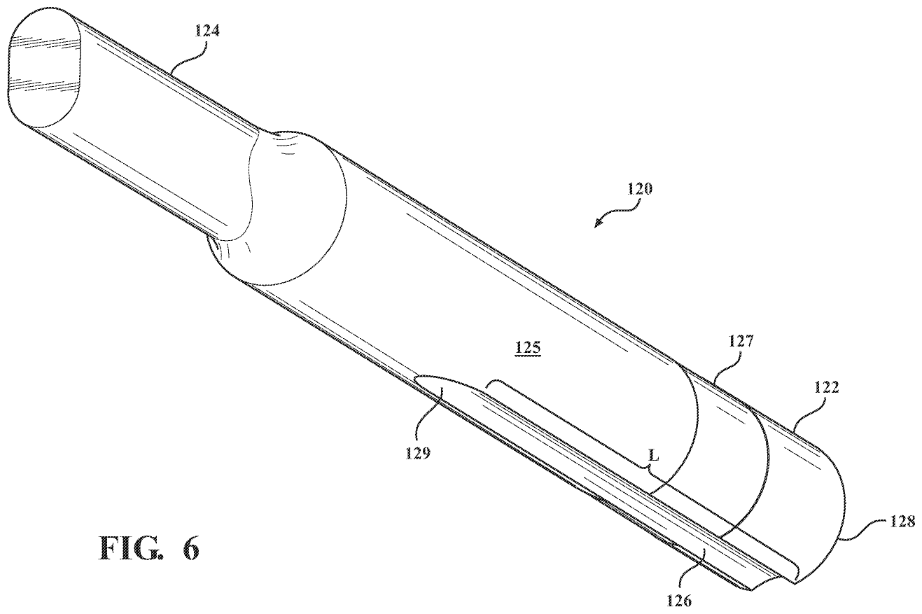

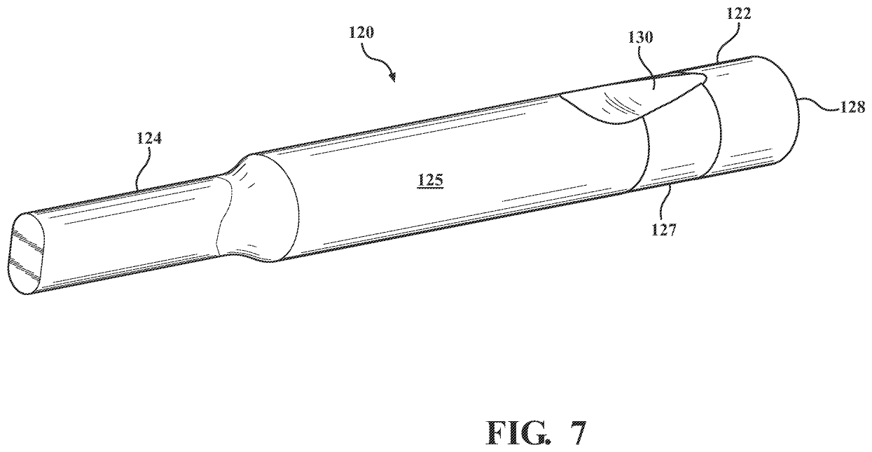

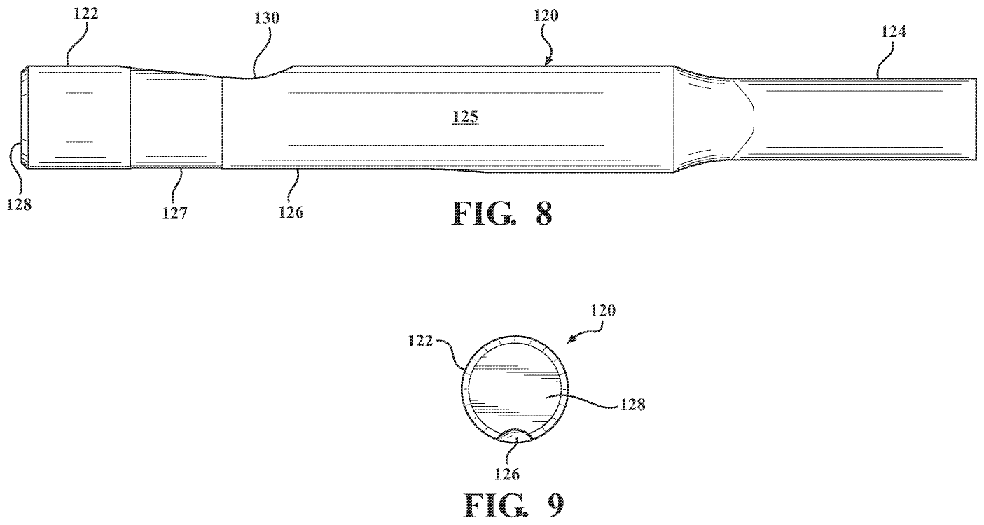

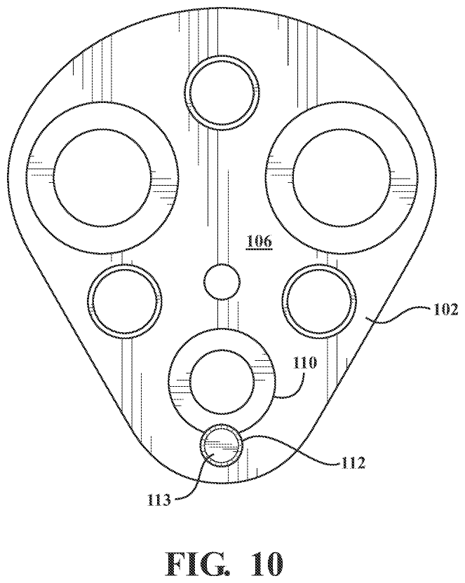

Referring now to FIGS. 6-9, the punch 120 is shown in more detail. FIGS. 6 and 7 are perspective views, FIG. 8 is a side view and FIG. 9 is an end view. These FIGS. are to scale for certain exemplary embodiments, but a wide range of dimensions is possible. The punch 120 may be said to have a punch body, also 120, extending from a base 122 to an opposite tip 124 for piercing materials. The base has a generally circular cross section. As used herein, the phrase “generally circular” means that the majority of the surface lies on a circle but the surface may have portions, such as recesses or protrusions, which do not lie on the circle. As one example, the base 122 of the punch 120 having a generally circular cross section means that the majority of the outer surface of the base lies on a circle, as shown in FIG. 9, but the base may have a portion cut away, as with the arcuate slot 126.

The arcuate slot 126 is an example of an alignment feature of the punch, which may take other forms in other embodiments. However, the arcuate slot is preferred for certain embodiments. In this example, the arcuate slot 126 is defined in the side surface 125 and extends from a bottom surface 128 of the base 122 towards the tip. Preferably, the arcuate slot 126 extends only far enough to somewhat exceed the depth of the punch hole. Alternatively, it may extend farther. As best shown in FIG. 6, the arcuate slot has a consistent depth and shape for most of its length, but then washes out or smoothly transitions into the side surface 125 of the punch at its upper end 129. As used herein, the “length” of the slot is defined as extending from the bottom surface 128 only as far as the slot has the consistent shape and depth. This length is marked as L in FIG. 6. The punch may have a bevel where the bottom surface 128 meets the side surface 125, though this is optional. The punch may also optionally have a recessed band 127 in the side surface 125.

The punch also has a ball lock recess 130 in the side surface 125 for receiving the spring-loaded ball for locking the punch into the punch hole. The shape and position of the recess may be as traditionally used. In this example, the ball lock recess 130 is positioned 180 degrees from the arcuate slot, as measured from the deepest spots of each.

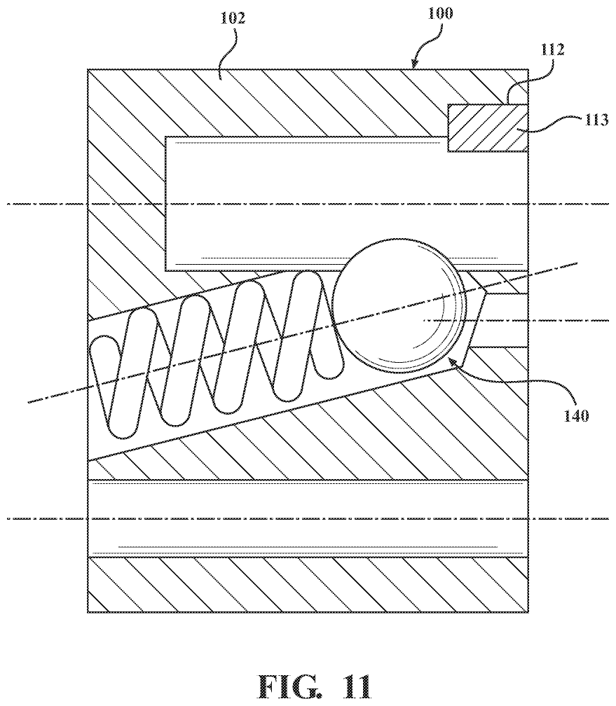

FIGS. 10 and 11 provide an end view and a cross sectional side view, respectively, of the retainer 100. These drawings are to scale for certain embodiments but are not limiting on other embodiments. According to the present invention, an orientation element 112 extends at least partially into the generally circular punch hole 110. In this example, the orientation element 112 is defined by a portion of a cylindrical dowel 113 extending part way into the body 102 of the retainer 100. The dowel 113 is received in a dowel hole 114 that partially overlaps the punch hole 110. The center of the dowel hole 113 is offset from the punch hole 110 by a distance such that a portion of the side of the dowel 113 extends into the circular punch hole 110 but the majority of the dowel is surrounding and retained by the body 102 of the retainer. Put another way, greater than 180 degrees of the circumference of the dowel is embedded in the wall of the punch hole 110 and less than 180 degrees extends into the punch hole. Put yet another way, more than 50% of the dowel is embedded in the retainer body and less than 50% protrudes. This serves to securely retain the dowel. In this example, the dowel hole 114 extends only part way to the bottom of the punch hole 110. In some examples, it extends less than 50%, less than 33% or less than 25% of the depth. In certain versions, the dowel hole extends approximately 33% and in certain other versions it extends 25%. Alternatively, it may extend farther.

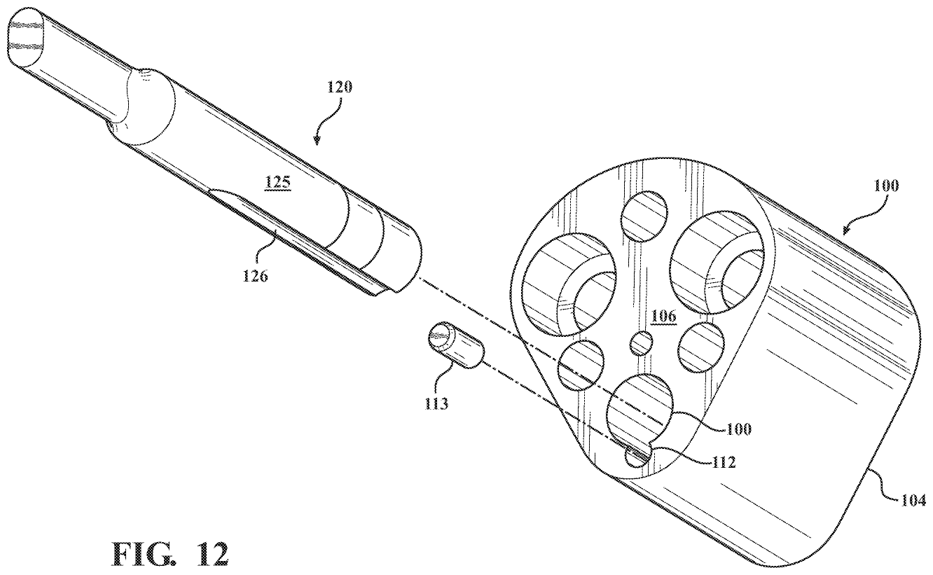

FIG. 12 provides an exploded view of the punch system 90, including the punch 120 and retainer 100, with the dowel 113 separated from the dowel hole. As shown, the arcuate slot 126 in the side surface 125 of the punch 120 and the orientation element defined by the surface of the dowel 113 have complementary shapes. That is, the radius of curvature of each is similar so that they engage with one another to properly position the punch in the retainer.

The present invention also provides a method for providing a punch system 90. A punch or punch body 120 is provided. A ball lock recess 130 is defined in the side surface 125. An alignment feature is defined in the side surface 125. In the illustrated examples, the alignment feature is a slot with an arcuate cross section. A punch retainer body 102 is provided and a punch hole 106 is defined therein. A ball lock mechanism 240 is provided, with a ball that is spring biased into a locking position where the ball extends partially into the punch hole. An orientation element is provided in the punch retainer, extending partially into the punch hold. In the illustrated examples, the orientation element is formed by a protruding portion of the dowel 113.

As discussed previously, in certain embodiments, the slot 126 has a length that is only somewhat longer than the depth of the punch hole 106. In examples, the slot length is chosen such that the dowel 113 cannot exit the dowel hole 112 once the punch 120 is locked into the punch retainer 100 by the ball lock mechanism. That is, the slot is not long enough for the dowel to move out of the dowel hole; instead the dowel would be blocked by the outer end of the slot, where it washes out into the side surface. In an example, the slot 126 has a length greater than or equal to the punch hole depth but less than the sum of the punch hole depth and the dowel hole depth. In another example, the slot 126 has a length in the range of 100% to 120% of the punch hole depth.

As illustrated, the diameter of the dowel 113 is typically much smaller than the diameter of the punch hole. In examples, the dowel has a diameter of 4 mm or 5 mm. In certain examples, the punch hole has a diameter of approximately 10 mm and the corresponding dowel has a diameter of 4 mm. In certain further examples, the punch hole has a diameter of approximately 13, 16, 20, 25, 32 or 40 mm and the corresponding dowel has a diameter of 5 mm. Other sizes and ranges are possible.

The punch retainer 100 includes a ball lock mechanism 140 similar to the design shown in FIG. 2. In this example, the position of the ball and the position of the orientation element are directly opposed to each other, 180 degrees apart in the hole. Likewise, the arcuate slot 126 and recess 130 in the punch are directly opposed, 180 degrees apart on the base. Alternatively, the relative positions of the elements may be different, as long as the retainer and punch match. However, 180 degrees apart is preferred for some embodiments as it provides a visual reference for proper positioning.

The present invention is not limited to retainers having the shape and structure shown in FIGS. The present invention may also form part of a retainer insert such as shown in PCT Patent Application No. PCT/US2019/014724, the entire contents of which is incorporated herein by reference.

1. A punch system for use with a punch press, comprising:
a punch and a punch retainer configured to receive and retain the punch;
the punch comprising;
a punch body having a tip for piercing material and a base to be received in the punch retainer;
a ball lock recess defined in a side surface of the base;
an alignment feature defined in the side surface of the base,
extending from an end surface of the base towards the tip;
the punch retainer comprising;
a retainer body having a mounting surface for attachment to a punch press and an opposite outer face;
a punch hole extending from the outer face at least part way to the mounting surface for receiving the base of the punch, the punch hole having a generally circular cross section;
a spring loaded ball biased into a locking position wherein the ball partially extends into the punch hole;
an orientation element extending partially into the punch hole, the orientation element having a shape complementary to the alignment element in the base of the punch such that the base of the punch is only insertable into the punch hole in an orientation in which the ball lock recess in the base of the punch is rotationally aligned with the spring loaded ball.

2. The punch system according to claim 1, wherein the alignment feature of the punch comprises a slot defined in the side surface of the base, extending from an end surface of the base towards the tip, the slot having an arcuate cross section;

3. The punch system according to claim 1, wherein the punch retainer comprises a dowel hole defined in the outer face adjacent to the punch hole and partially overlapping therewith; and
a cylindrical dowel received in the dowel hole such that a portion of a side of the cylindrical dowel extends partially into the punch hole so as to define an arcuate protrusion, the arcuate protrusion defining the orientation element, wherein preferably the arcuate protrusion has a shape complementary to the arcuate slot in the side surface of the punch.

4. The punch system according to claim 3, wherein the dowel hole has a depth less than a depth of the punch hole.

5. The punch system according to claim 2, wherein:
the in the side surface of the punch has a length greater than the depth of the punch hole and less than a sum of the depth of the punch hole and the depth of the dowel hole;
whereby the dowel cannot exit the dowel hole when the punch is retained in the punch retainer.

6. The punch system according to claim 3, wherein less than 50% of the dowel defines the arcuate protrusion and more than 50% of the dowel is embedded in the retainer body.

7. The punch system according to claim 2, wherein:
the punch hole has a depth;
the slot in the side surface of the punch having a length equal to or greater than the depth of the punch hole and less than a length of the punch.

8. The punch system according to claim 7, wherein the length of the slot is in the range of 100% to 120% of the depth of the punch hole.

9. The punch system according to claim 1, wherein the alignment feature of the punch is disposed 180 degrees from the ball lock recess.

10. A punch for use with a ball lock punch retainer having an orientation element extending partially into a punch hole in the retainer, the punch comprising:
a punch body having a tip for piercing material and a base to be received in the punch retainer;
a ball lock recess defined in a side surface of the base;
an alignment feature defined in the side surface of the base, extending from an end surface of the base towards the tip, the alignment feature being configured to be complementary to the orientation element.

11. The punch according to claim 10, wherein:
the alignment feature of the punch comprising a slot in the side surface of the base.

12. The punch according to claim 11, wherein:
the slot has an arcuate cross section.

13. The punch according to claim 11, wherein:
the slot in the side surface of the punch having a length less than a length of the punch.

14. The punch according to claim 10,
wherein the alignment feature of the punch is disposed 180 degrees from the ball lock recess.

15. A punch retainer for use with a punch of the type having a base with an alignment feature and with a generally circular cross section and a recess for receiving a ball, the punch retainer comprising:
a retainer body having a mounting surface for attachment to a punch press and an opposite outer face;
a punch hole extending from the outer face at least part way to the mounting surface for receiving the base of the punch, the punch hole having a generally circular cross section;
a spring loaded ball biased into a locking position wherein the ball partially extends into the punch hole;
an orientation element extending partially into the punch hole, the orientation element being configured to be complementary to the alignment feature in the base of the punch.

16. The punch retainer according to claim 15, further comprising:
a cylindrical dowel; and
a dowel hole defined in the outer face adjacent to the punch hole and partially overlapping therewith;
wherein the cylindrical dowel is received in the dowel hole such that a portion of a side of the cylindrical dowel extends partially into the punch hole so as to define an arcuate protrusion, the arcuate protrusion defining the orientation element.

17. The punch retainer according to claim 16, wherein the dowel hole has a depth less than a depth of the punch hole.

18. The punch retainer according to claim 16, wherein less than 50% of the dowel defines the arcuate protrusion and more than 50% of the dowel is embedded in the retainer body.

19. The punch retainer according to claim 15, wherein the orientation element is disposed 180 degrees from the spring-loaded ball.

20. A method of providing a punch system for use with a punch press, comprising:
providing a punch having a tip for piercing material and a base to be received in a punch retainer;
defining a ball lock recess in a side surface of the base;
defining an alignment feature in the side surface of the base, extending from an end surface of the base towards the tip;
providing a punch retainer body having a mounting surface for attachment to a punch press and an opposite outer face;
defining a punch hole extending from the outer face at least part way to the mounting surface for receiving the base of the punch, the punch hole having a generally circular cross section;
providing a spring loaded ball biased into a locking position wherein the ball partially extends into the punch hole;
providing an orientation element extending partially into the punch hole, the orientation element having a shape complementary to an alignment feature in the base of the punch such that the base of the punch is only insertable into the punch hole in an orientation in which the recess in the base of the punch is rotationally aligned with the spring loaded ball.

21. The method according to claim 20, wherein the step of providing the orientation element in the punch retainer body comprises:
defining a dowel hole in the outer face adjacent to the punch hole and partially overlapping therewith;
providing a cylindrical dowel; and
receiving the cylindrical dowel in the dowel hole such that a portion of a side of the cylindrical dowel extends partially into the punch hole so as to define an arcuate protrusion, the arcuate protrusion defining the orientation element.

22. The method according to claim 21, wherein the step of defining the dowel hole comprises defining a dowel hole with a depth less than a depth of the punch hole.

23. The method according to claim 21, wherein:
the step of defining the alignment feature in the side surface of the punch comprises defining a slot having an arcuate cross section, the slot having a length greater than the depth of the punch hole and less than a sum of the depth of the punch hole and the depth of the dowel hole;
whereby the dowel cannot exit the dowel hole when the punch is retained in the punch retainer.

24. The method according to claim 21, wherein the step of defining the dowel hole comprises positioning the dowel hole such that less than 50% of the dowel defines the arcuate protrusion and more than 50% of the dowel is embedded in the retainer body.

25. The method according to claim 20, wherein the orientation element is disposed 180 degrees from the spring-loaded ball.
